(19) United States
(12) Patent Application Publication
(10) Pub. No.: US 2013/0181954 A1
(43) Pub. Date: Jul. 18, 2013

(54) ELECTRONIC BRUSH

(71) Applicants: Antonio Carlos Camargo Do Amaral, Campinas-Sao Paulo (BR); Alaide Pellegrini Mammana, Campinas -Sao Paulo (BR); Daniel Den Engelsen, Campinas-Sao Paulo (BR)

(72) Inventors: Antonio Carlos Camargo Do Amaral, Campinas-Sao Paulo (BR); Alaide Pellegrini Mammana, Campinas -Sao Paulo (BR); Daniel Den Engelsen, Campinas-Sao Paulo (BR)

(73) Assignee: CENTRO DE TECNOLOGIA DA INFORMACAO RENATO ARCHER-CTI, Sao Paulo (BR)

(21) Appl. No.: 13/823,613

(22) PCT Filed: Sep. 21, 2011
(86) PCT No.: PCT/BR2011/000373

§ 371 Date: Mar. 14, 2013

(30) Foreign Application Priority Data
Sep. 22, 2010 (BR) PI1003655-5

(51) Int. Cl. G06F 3/0354

(52) U.S. Cl. CPC G06F 3/03545
USPC 345/179

(57) ABSTRACT

The “ELECTRICAL BRUSH” is a simulation device of a brush composed by multiple conductive bristles, mounted along with the normal bristles used in normal brushes (natural or synthetic fibers). Its conductive bristles receive electrical stimuli coming from a drawing surface and determine, precisely, the coordinates (X,Y) of the point that was touched.

The present request for patent of invention object of description and claim of this report is about an inventive solution with the application field directed to the well-known tablets, which can be translated in a way of ELECTRONIC BRUSH precisely simulating, with veracity, within the virtual environment, bringing a series of inedited and innovative technical advantages.

The ELECTRONIC BRUSH, in turn, is composed by multiple conductive bristles, which, when receiving stimulations on a drawing surface retransmits the lines applied by the user in the computer screen with more reliability. Each bristle of the ELECTRONIC BRUSH is responsible for providing exactly the brushstrokes of the surface to the coordinates of the screen (x,y) and the bristles also have sensors which determine the inclination of the brush. The ELECTRONIC BRUSH keeps the same format of the common paintbrush, with its own bristles and handle, the difference is the possibility to change the upper part of the ELECTRONIC BRUSH, replacing the bristles with the desired format and size. It can be connected with wires or be wireless.

Thus, it is conclusive that the inedited ELECTRONIC BRUSH is provided with a novelty request, thanks to the concept of precision in the creation of images in the computer screen. The multiple conductive bristles will provide a more precise and authentic sensing of the coordinates, a fact that will result in a simulation system, as close as possible to the reality of use of a real brush with paint. The ELECTRONIC BRUSH may be used preferably over a transparent drawing surface or over a non-transparent surface, and this innovation converges for an inventive activity, with industrial application, meeting the requirements of patentability, especially as a patent of invention, according to the provisions of the Article 8 of the Law No. 9.279.

### PRINCIPLES OF THE TECHNIQUE

In order to propitiate veracity to the context specified in the introductory framework, a brief explanation about the state of art for the ELECTRONIC BRUSHes or electronic pens and the existing problems will be presented, and it will be possible to a technician versed on the subject to recognize the limiting aspects which guide the need for development and application of innovations which converge for the “ELECTRONIC BRUSH” which is object of claim of this request of patent of invention.

There are several models of electronic pens in the market, digitizing tablets with peripheral device, allowing people to draw directly in the computer, normally through image editing software, those digital tablets have flat surfaces over which the user may draw an image using a device similar to a pen, named “stylus”. Generally, the image does not appear in the tablet itself, but it is simultaneously shown on the screen of the computer. Originally developed as electronic device, later started to have the function to draw on the tablet surface with precise lines, but yet using a pointer, different from the ELECTRONIC BRUSH, which will be mounted along with bristles of a normal brush and with only one handle, with the possibility to change the several types of tops, commonly used in normal brushes.

The modern graphic tablets use mainly electromagnetic induction, where the tablet itself works as a transmitter and receiver coil. The tablet generates a signal, changes the capacitance, which reflects in the signal generated by the pen. Some pen tips also provide voltage information, but the electronic components for such information are present in the tip itself, not on the tablet. However, such technologies do not allow the use of transparent graphic screens and do not represent the technical effects of the conventional painting.

The current ELECTRONIC BRUSHes have several operational methods. There is one type of ELECTRONIC BRUSH with CCD optical sensor, which acts over a non-transparent drawing surface, over a monitor or over a colorful palette. Those ELECTRONIC BRUSHes reproduce the colors its optical sensor—formed by optical fiber bundles—captures, and then it draws the colors in a monitor (U.S. Pat. No. 5,420,607 and U.S. Pat. No. 6,603,46381), Other ELECTRONIC BRUSHes with capacitive sensing, which act over a drawing surface with the features of a capacitive tablet. The brush has bristles with ohm resistance close to the human skin, when touching the brush over the capacitive surface, the system works as a capacitive “touch screen”, with the difference that the pointer is a brush imitating the touch of a human finger (U.S. Pat. No. 5,488,204). There is, still, an ELECTRONIC BRUSH with elastic bristles spaced out, with the function to touch, over a conventional resistive “touch screen” as a normal pointer (pen) (U.S. Pat. No. 5,861,878) Other ELECTRONIC BRUSHes have non-conductive bristles, with a soft tip, imitating the tip of a brush, acting over a drawing surface as a conventional resistive touch screen (U.S. Pat. No. 6,801,211B2 2003/0117408A1).

### PROPOSAL OF THE INVENTION

in light of the foregoing, the plaintiff idealized an “ELECTRONIC BRUSH”, where it is indicated in a set of inedited innovations, among them, the conception of a transparent conductive screen with a line of diodes, side by side, equally spaced out along each margin of the glass, allowing the conduction of the voltage between the horizontal and vertical axis with a microcontroller as described in the U.S. Pat. No. 6.954.078 of the Centro de Pesquisas Renato Archer-CTI (MCT) (U.S. Pat. No. 6.954.078).

The present invention determines, precisely, the coordinates (X,Y) of a point touched over a screen through multiple conductive bristles connected to a circuit which is responsible for the measurement of the voltage applied in the distributed resistor, constituted by a thin foil continuous and transparent over the glass substrate. A voltage applied on the horizontal axis during a specific period of time and, alternately, on the vertical axis, through a switching circuit, in a way that the value of the voltage measured by the conductive bristles, in a given time, is directly related to its position, whether on the “X” or on the “Y” axis, since the transparent and conductive foil is uniform enough along the whole screen. To comply with this linearity, the current lines in the “X” and “Y” directions are parallel, conditioned to a uniform electric field along the screen, in each measure interval obtained with the application of the same voltage along each margin of the screen.

### DESCRIPTION OF THE FIGURES

to complement the Current description in a way to obtain a better understanding of the characteristics of the present request of invention, a set of drawings is attached to it, where, in an exemplified—but not restrictive—manner, a way to execute the “ELECTRONIC BRUSH” here claimed was represented, where:

FIG. 1 is a representation of the circuit of controls of the “ELECTRONIC BRUSH”;

FIG. 2 is a graphic representation of the switch between the coordinates of the screen (X,Y) of the “ELECTRONIC BRUSH”;

FIG. 3 is a representation of the conductive bristles intertwined with the normal bristles of the “ELECTRONIC BRUSH”;

FIG. 4 is a representation of the switching Keys of the conductive bristles of the “ELECTRONIC BRUSH”;

FIG. 5 is a representation of the electric scheme of the “ELECTRONIC BRUSH”;

FIG. 6 represents the normal types of brushes that can be used by the “ELECTRONIC BRUSH”;

FIG. 7 represents a drawing made by the “ELECTRONIC BRUSH” using the program TuxPaint in the educational Linux 2.0 operational system;

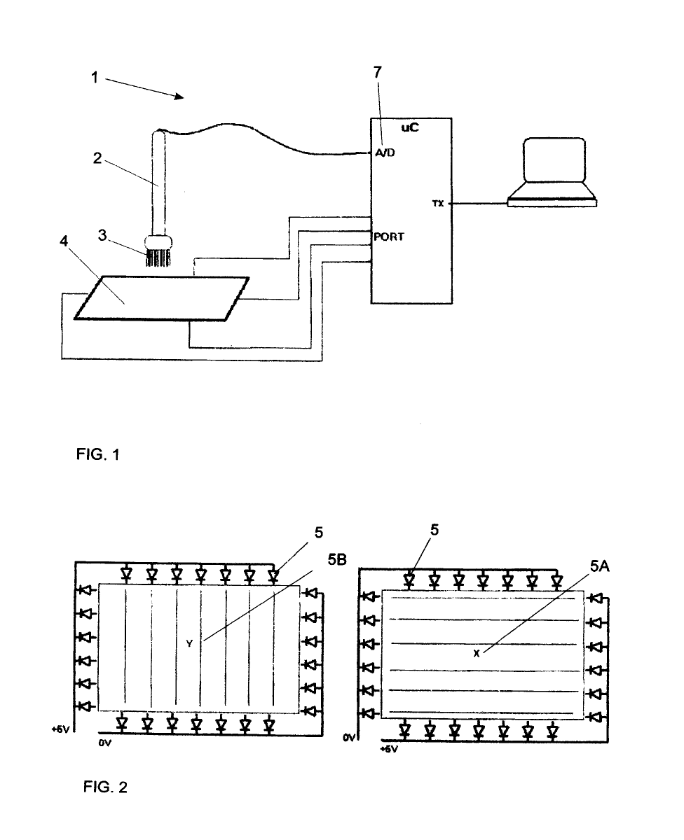

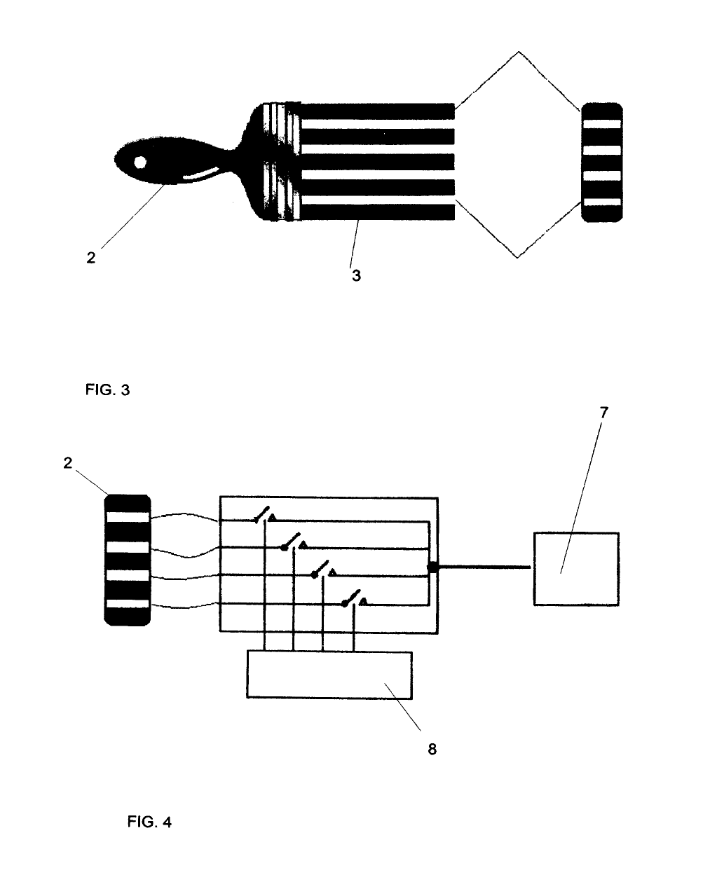

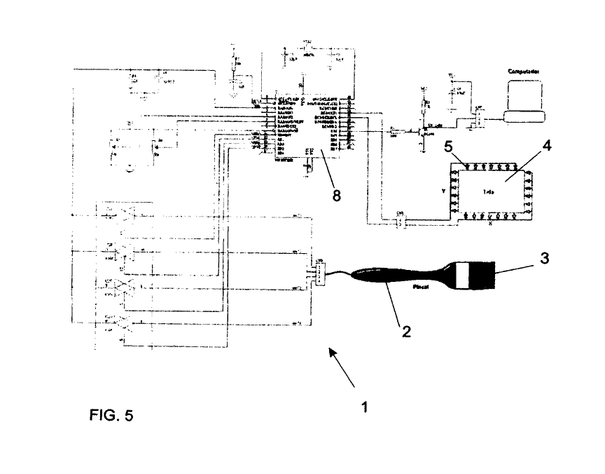

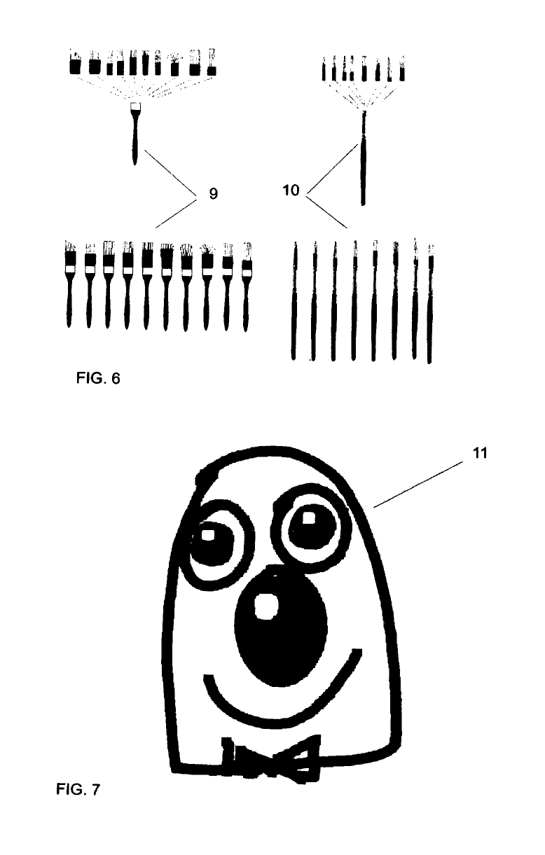

### DETAILED DESCRIPTION

the following detailed description shall be read and interpreted referring to the presented drawings, highly diagrammatic, representing a form to execute the “ELECTRONIC BRUSH”, and it is not intended to restrict the scope of the invention, which is limited only to what was explained in the set of claims.

“ELECTRONIC BRUSH”, which digitizing of the contact of a brush with a screen using an A/D converter consists on a device (1) including an ELECTRONIC BRUSH (2) with multiple conductive bristles (3), which receive stimuli coming from a transparent surface (4), preferably a resistive transparent surface, and each conductive bristle (3) of the ELECTRONIC BRUSH (2) reads the coordinates (X,Y) through the direct contact over the transparent surface (4) or through electric induction, acting as a distributed resistance that, when a square voltage is applied, from zero to five Volts, with frequency of approximately 2 kHz, in diodes (5) uniformly distributed on the margins of the transparent surface (4), in a way to form current lines in the parallel x and y directions; such diodes (5) are disposed and mounted in half-cycle with the diodes (5A) on the X direction conduct, while in the half-cycle only the diodes (5B) on the Y direction are conducting and the pointer sequentially reads the voltages which are proportional to the X coordinate and the Y coordinate;

The switching between both coordinates promoted and oriented by the diodes (5) of each margin of the transparent surface (4) in the same direction of the diodes (5) of the opposite margin and leading the terminals of each pair of adjacent lines of diodes to a short-circuit, and when the diodes of the horizontal axis (5A) are directly polarized, they allow the electric passage and the sensing of the voltage in this direction; the diodes (5B) of the reversely polarized vertical axis, avoiding the passage of the current and the sensing in the other direction, obtaining the value of the “X” coordinate of the pointer.

Each conductive bristle (3) is connected to an electronic switch (6) which closes in a given period of time, making contact with the input of an analog to digital converter A/D (7).

The device (1) includes a microcontroller (8) as a command unit for the ELECTRONIC BRUSH (2) which applies the voltages in the x and y directions of the transparent surface (4) conductor (screen);

Such microcontroller reads and converts the A/D of the voltages detected by the conductive bristles (3) of the ELECTRONIC BRUSH (2) switching the multiple conductive bristles (3) with a data pre-processing of the x and y coordinates so that they can be interpolated by the micro-computer through a serial communication with the computer.

The diodes (5B) of the vertical axis are directly polarized and, consequently, the ones of the horizontal axis (5A) are reversely polarized, obtaining the value of the “Y” coordinate of the ELECTRONIC BRUSH (2)

A voltage is applied on the horizontal axis during a specific period of time and, alternately, on the vertical axis, through a switching circuit, in a way the value of the voltage measured by the conductive bristles in a given moment is directly related to its position, whether on the “X” axis or on the “Y” axis, since the transparent and conductive foil is uniform enough along the whole screen. Current lines in the “X” direction and in the “Y” direction are parallels conditioned to a uniform electric field along the screen, in each interval of measurement obtained with the application of the same voltage along each margin of the screen.

The micro-controlled command unit (8) of the ELECTRONIC BRUSH is based on an 8 bit commercial microcontroller, 28 pins, 256 bytes of RAM and 5 8 bit analog inputs (PIC 16F876A) executing the following functions: application on the voltages, on the X and Y directions of the transparent conductive foil (screen); A/D conversion and reading of the voltages detected by the bristles of the brush; switching of the multiple conductive bristles; data pre-processing of the x and y coordinates so that they can be interpolated by the micro-computer; and serial communication with the computer.

The “ELECTRONIC BRUSH” has, therefore, features that allow drawing or even painting in a way the user intuitively interacts, providing an experience that is similar to draw over a common canvas. The “ELECTRONIC BRUSH”, object of this patent, is not only a simulacrum of a digital pointer and with the appropriate software is even possible to move and resize objects, open programs, selecting items from the menus, improving the man-machine communication channel on a new perspective.

By what was here described and illustrated, we verify that the “ELECTRONIC BRUSH” now claimed fits to the rules governing the Patent of Invention according to the Industrial Property Law, and deserves, by what was shown and as a result of it, the respective privilege.

1) “ELECTRONIC BRUSH” which digitalization (scan) of the contact of a brush with a screen, using an A/D converter characterized by a device (1) including an ELECTRONIC BRUSH (2) with multiples conductive bristles (3), which receive stimuli coming from a conductive surface (4), preferably a transparent surface, with resistance (SnO2), and each conductive bristle (3) of the ELECTRONIC BRUSH (2) reads the coordinates (X,Y) through the direct contact over the transparent surface (4) or through electrical induction, acting as a distributed resistance that, when a square voltage is applied, from zero to five Volts with frequency of approximately 2 kHz in diodes (5) which are uniformly distributed on the margins of the transparent surface (4), in a way to form current lines in the parallel X and Y directions; such diodes (5) are disposed and mounted, in half-cycle with the diodes (5A) on the X direction conduct, while in half-cycle, only the diodes (5B) on the Y direction are conducting, and the pointer sequentially reads the voltages which are proportional to the X coordinate and the Y coordinate; and as it switches between both coordinates promoted and oriented by the diodes (5) of each margin of the transparent surface (4) in the same direction of the diodes (5) of the opposite margin and leading the terminals of each pair of adjacent lines of diodes to a short-circuit, and when the diodes of the horizontal axis (5A) are directly polarized, they allow the electric passage and the sensing of the voltage in this direction; the diodes (5B) of the reversely polarized vertical axis, avoiding the passage of the current and the sensing in the other direction, obtaining the value of the “X” coordinate of the pointer.

2) “ELECTRONIC BRUSH”, according to the claim 1, characterized by a conductive bristle (3) is connected to an electronic switch (6) which closes in a given period of time, making contact with the input of an analog to digital converter A/D (7).

3) “ELECTRONIC BRUSH”, according to the claim 1, characterized by the fact of the device (1) includes a micro-controller (8) as a command unit for the ELECTRONIC BRUSH (2) which applies the voltages on the x and y directions of the transparent surface (4) conductor (screen); and that the microcontroller reads and converts the A/D of the voltages detected by the conductive bristles (3) of the ELECTRONIC BRUSH (2) switching the multiple conductive bristles (3) with a data pre-processing of the x and y coordinates so that they can be interpolated by the micro-computer through a serial communication with the computer.

4) “ELECTRONIC BRUSH”, according to claim 1, characterized by the fact that the diodes (5B) of the vertical axis are directly polarized and, consequently, the ones of the horizontal axis (5A) are reversely polarized, obtaining the value of the “Y” coordinate of the ELECTRONIC BRUSH (2).

5) “ELECTRONIC BRUSH”, according to the claim 1, characterized by having a voltage applied on the horizontal axis during a specific period of time and, alternately, on the vertical axis, through a switching circuit, in a way the value of the voltage measured by the conductive bristles in a given moment is directly related to its position, whether on the “X” axis or on the “Y” axis, since the transparent and conductive surface (4) is uniform enough along the whole screen.

6) “ELECTRONIC BRUSH”, according to claim 1 characterized by having the current lines in the “X” direction and in the “Y” direction are parallels conditioned to a uniform electric field along the screen, in each interval of measurement obtained with the application of the same voltage along each margin of the screen.

7) “ELECTRONIC BRUSH”, according to the claim 1 is characterized by the fact that each bristle is responsible for reading a coordinate of the screen (x,y) and the multiple bristles are disposed side by side, map the region touched by the brush on the surface of drawing, making thus an image of the area of touch of the brush.

8) “ELECTRONIC BRUSH”, according to the claim 1, characterized by the fact that the same format and size of a common paintbrush, with its conductive bristles fixed on the tip of an appropriate handle.

9) “ELECTRONIC BRUSH”, according to the claim 1, characterized by the fact that the change of type of the tip (set of bristles) equal to the ones normally used on the common brushes, and the tip can be changed, using the same handle of the brush (9), (10).

10) “ELECTRONIC BRUSH”, according to the claim 1, characterized by the fact that it may have the following shapes: stroke, short bright (flat), bright, flat, filbert, angular, fan, paintbrush, spatter, gilder's tip.

11) “ELECTRONIC BRUSH”, according to the claim 1, characterized by the fact that it may have the following shapes: round, spotter, liner, showcard, striper, mop, stencil, and pipe.

12) “ELECTRONIC BRUSH”, according to the claim 1, characterized by the fact that it presents conductive bristles with thin hair of conductive material or with fibers of any material, natural or synthetic, covered with a conductive layer.

13) “ELECTRONIC BRUSH”, according to the claim 1, characterized by he fact that it presents sensor bristles to determine the inclination of the brush or inclinometer of the fixture handles.

14) “ELECTRONIC BRUSH”, according to the claim 1, characterized by the fact that it presents a connector via wires or wireless.

15) “ELECTRONIC BRUSH”, according to the claim 1, characterized by the fact that it may be used over a transparent and non-transparent drawing surface.
